(19) United States
(12) Patent Application Publication
(10) Pub. No.: US 2009/0194993 A1
(43) Pub. Date: Aug. 6, 2009

(54) Converter that converts multiple faucets into one faucet

(76) Inventor: Kun Yuan Tong, Suwanee, GA (US)

Correspondence Address: Kun Yuan Tong, 2842 Lowe Court, Suwanee, GA, 30024, US

(21) Appl. No.: 12/012,710

(22) Filed: Feb. 5, 2008

(51) Int. Cl. F16L 41/02; F16L 41/03

(52) U.S. Cl. 285/131.1; 137/603; 285/125.1

(57) ABSTRACT

A converter that converts multiple faucets into one faucet comprises multiple inlet faucets and one outlet faucet. This converter receives a large amount of high pressure water from multiple garden hoses that are connected to multiple open faucets to increase a very high water pressure in this converter. We can let this very high pressure water come out the inlet of converter to wash floor.

### THE BACKGROUND OF THE INVENTION

We use nozzle to spray high pressure water to wash floor. Sometime the water pressure is not strong enough to clean some dirty spots. Converter that converts multiple faucets into one faucet can create a higher water pressure to clean these dirty spots.

### THE BRIEF SUMMARY OF THE INVENTION

One faucet can provide a certain amount of high pressure water to wash floor. Two faucets add together will provide a higher pressure water to wash floor. Three faucets add together will provide a much higher pressure water to wash floor. Therefore if we convert multiple faucets into one faucet outlet we can get a much higher pressure water.

### THE DETAILED DESCRIPTION OF THE INVENTION

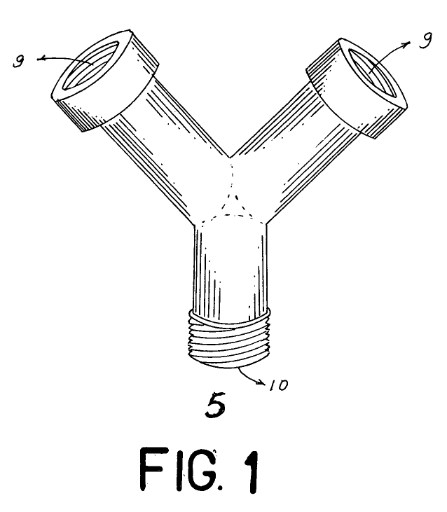

FIG. 1 is a perspective view of converter that converts two faucets into one faucet.

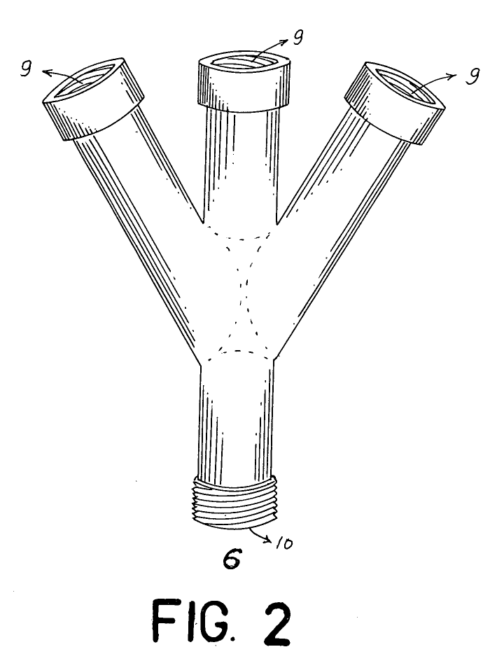

FIG. 2 is a perspective view of converter that converts three faucets into one faucet.

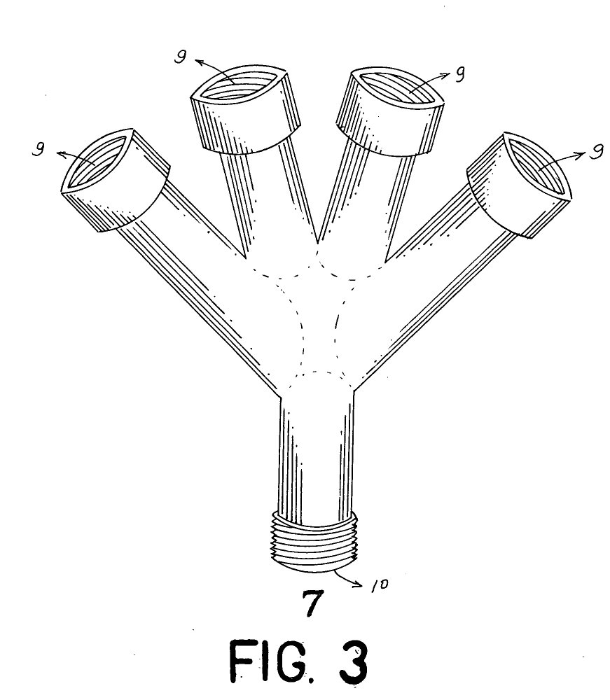

FIG. 3 is a perspective view of converter that converts four faucets into one faucet.

### THE DETAILED DESCRIPTION OF THE INVENTION

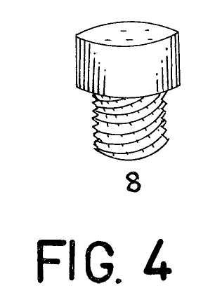

Referring now in detail to the drawings numeral 5 of FIG. 1 is a converter that converts two faucets into one faucet. Numeral 6 of FIG. 2 is a converter that converts three faucets into one faucet. Numeral 7 of FIG. 3 is a converter that converts four faucets into one faucet. Each converter 5, 6 and 7 has inlet 9 and outlet 10. Numeral 8 of FIG. 4 is a stopper that screws into the unused inlet 9 of converters 5, 6 and 7. Each garden hose from different faucet screws into the inlet 9 of converter can provide a certain high pressure water. Multiple garden hoses from different faucets connect to multiple inlets 9 of converter 5, 6 or 7 can provide a much higher pressure water. If we use this converter we can wash and clean floor much easier and cleaner.

1. Converter that converts multiple faucets into one comprising a faucet that has multiple inlets and one outlet and many stoppers.

2. The said multiple inlets of the said faucet in claim 1 can be two, three or more that connect to two, three or more garden hoses to receive water.

3. The said one outlet in claim 1 is only one and connects to a garden hose to spray water.

3. The said stoppers in claim 1 insert into unused the said inlets in claims 1 and 2.
